(19) United States
(12) Patent Application Publication
(10) Pub. No.: US 2026/0079549 A1
(43) Pub. Date: Mar. 19, 2026

(54) POWER BYPASS OF MOTHERBOARD FOR GRAPHICS PROCESSING UNIT

(71) Applicant: Dell Products L.P., Round Rock, TX (US)

(72) Inventors: Qinghong HE, Austin, TX (US); Ihab SAAD, Austin, TX (US)

(73) Assignee: Dell Products L.P., Round Rock, TX (US)

(21) Appl. No.: 18/887,934

(22) Filed: Sep. 17, 2024

(51) Int. Cl. G06F 1/26; G06F 1/3203

(52) U.S. Cl. CPC G06F 1/263; G06F 1/3203

(57) ABSTRACT

An information handling system may include a motherboard, a first processor mounted on the motherboard and electrically coupled to the motherboard and configured to receive electrical energy for powering the first processor via the motherboard and communicate signals via the motherboard, a second processor mounted on the motherboard and electrically coupled to the motherboard and configured to communicate signals via the motherboard, and a power converter module configured to convert an input voltage to an output voltage and deliver the output voltage via a dedicated cable coupled between the power converter module and the second processor.

### TECHNICAL FIELD

The present disclosure relates in general to information handling systems, and more particularly to systems and methods for delivering power to a graphics processing unit in a manner which bypasses a motherboard upon which the graphics processing unit is communicatively coupled.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

In information handling systems powered by Universal Serial Bus (USB) Type-C alternating current (AC) adapters, a battery charger and key voltage regulators may operate at the USB Type-C Standard Power Range (SPR). In a system powered by an Extended Power Range (EPR) USB Type-C AC adapter, an EPR-to-SPR conversion module may be required in the information handling system. In existing approaches, such module may be implemented on a daughterboard coupled to a motherboard. If the system is equipped with a graphics processing unit or “graphics card,” power may be supplied to the graphics processing unit at the SPR power level, after going through sensing and switching circuitry and on to a graphics card connector.

Due to the high power consumed by high-end graphics processing units, routing the graphics power through the main motherboard of an information handling system may consume substantial routing space on the board. In addition, such routing may also consume a large number of pins on the graphics connector. Graphics connectors are typically expensive and large in size due to the large number and high speed of the graphics signals. The addition of power pins increases both connector's cost and size and reduces motherboard space available for placement of other components.

### SUMMARY

In accordance with the teachings of the present disclosure, the disadvantages and problems associated with existing approaches to routing of power in an information handling system may be reduced or eliminated.

In accordance with embodiments of the present disclosure, an information handling system may include a motherboard, a first processor mounted on the motherboard and electrically coupled to the motherboard and configured to receive electrical energy for powering the first processor via the motherboard and communicate signals via the motherboard, a second processor mounted on the motherboard and electrically coupled to the motherboard and configured to communicate signals via the motherboard, and a power converter module configured to convert an input voltage to an output voltage and deliver the output voltage via a dedicated cable coupled between the power converter module and the second processor.

In accordance with these and other embodiments of the present disclosure, a power converter module may include a power converter configured to convert an input voltage to an output voltage and a power header configured to couple to a dedicated cable to deliver the output voltage via the cable.

In accordance with these and other embodiments of the present disclosure, a method may include coupling a power converter module to a processing device via a dedicated cable, wherein the power converter module is configured to convert an input voltage to an output voltage and deliver the output voltage to the processing device via the dedicated cable.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of selected components of an example information handling system, in accordance with embodiments of the present disclosure; and

FIG. 2 illustrates an isometric perspective view of selected components of the information handling system of FIG. 1, in accordance with embodiments of the present disclosure.

### DETAILED DESCRIPTION

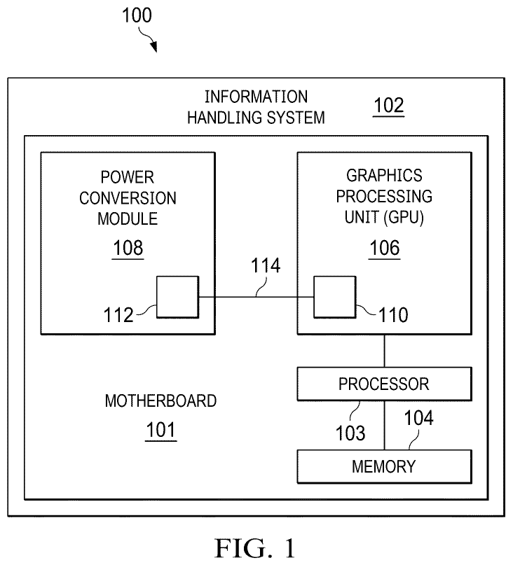

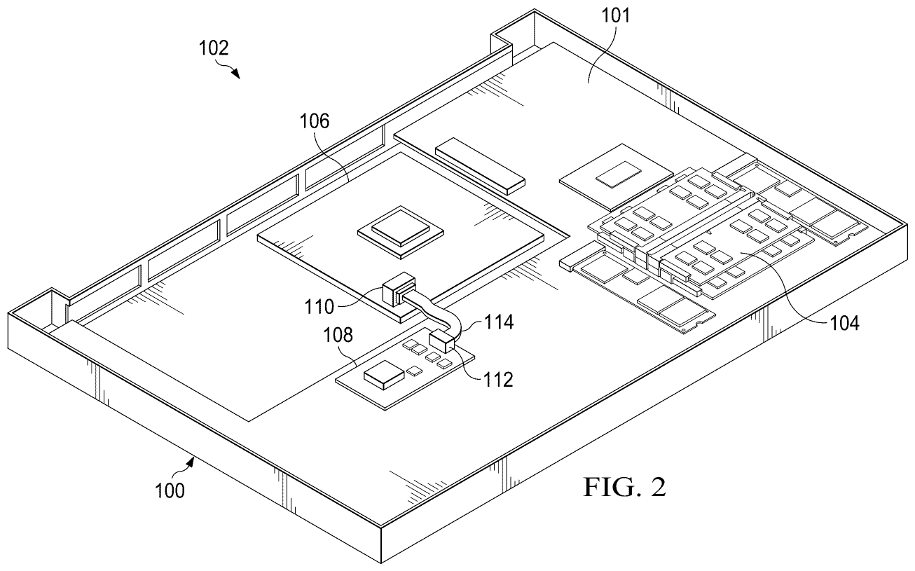

Preferred embodiments and their advantages are best understood by reference to FIGS. 1 and 2, wherein like numbers are used to indicate like and corresponding parts.

For the purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal data assistant (PDA), a consumer electronic device, a network storage device, or any other suitable device and may vary in size, shape, performance, functionality, and price. The information handling system may include memory, one or more processing resources such as a central processing unit (CPU) or hardware or software control logic. Additional components of the information handling system may include one or more storage devices, one or more communications ports for communicating with external devices as well as various input and output (I/O) devices, such as a keyboard, a mouse, and a video display. The information handling system may also include one or more buses operable to transmit communication between the various hardware components.

For the purposes of this disclosure, information handling resources may broadly refer to any component system, device or apparatus of an information handling system, including without limitation processors, service processors, basic input/output systems (BIOSs), buses, memories, I/O devices and/or interfaces, storage resources, network interfaces, motherboards, and/or any other components and/or elements of an information handling system.

For the purposes of this disclosure, circuit boards may broadly refer to printed circuit boards (PCBs), printed wiring boards (PWBs), printed wiring assemblies (PWAs), etched wiring boards, and/or any other board or similar physical structure operable to mechanically support and electrically couple electronic components (e.g., packaged integrated circuits, slot connectors, etc.). A circuit board may comprise a substrate of a plurality of conductive layers separated and supported by layers of insulating material laminated together, with conductive traces disposed on and/or in any of such conductive layers, with vias for coupling conductive traces of different layers together, and with pads for coupling electronic components (e.g., packaged integrated circuits, slot connectors, etc.) to conductive traces of the circuit board.

FIG. 1 illustrates a block diagram of selected components of an example information handling system 102, in accordance with embodiments of the present disclosure.

FIG. 2 illustrates an isometric perspective view of selected components of information handling system 102, in accordance with embodiments of the present disclosure.

As depicted in FIGS. 1 and 2, information handling system 102 may include a motherboard 101 and a cable 114 housed within a chassis 100. Chassis 100 may be an enclosure that serves as a container for various information handling resources, and may be constructed from steel, aluminum, plastic, and/or any other suitable material.

Although the term “chassis” is used, chassis 100 may also be referred to as a rack, case, cabinet, tower, box, enclosure, and/or housing. In certain embodiments, chassis 100 may be configured to hold and/or provide power to a plurality of information handling systems and/or information handling resources. For purposes of clarity and exposition, a portion of chassis 100 is removed in FIG. 2 to allow the reader to view the internal space of chassis 100.

Motherboard 101 may include a circuit board configured to provide structural support for one or more information handling resources of information handling system 102 and/or electrically couple one or more of such information handling resources to each other and/or to other electric or electronic components external to information handling system 102. As shown in FIG. 1, motherboard 101 may include a processor 103, memory 104, a graphics processing unit (GPU) 106, a power conversion module 108, and one or more other information handling resources, mounted thereon. Processor 103 may comprise any system, device, or apparatus operable to interpret and/or execute program instructions and/or process data, and may include, without limitation a microprocessor, microcontroller, digital signal processor (DSP), application specific integrated circuit (ASIC), or any other digital or analog circuitry configured to interpret and/or execute program instructions and/or process data. In some embodiments, processor 103 may interpret and/or execute program instructions and/or process data stored in memory 104 and/or another component of information handling system 102. Processor 103 may be mounted to motherboard 101 via a suitable connector or socket, and may be electrically coupled to motherboard 101 to enable communication of signals via motherboard 101 and enable processor 103 to receive electrical energy from motherboard 101 for powering processor 103.

Memory 104 may be communicatively coupled to processor 103 and may comprise any system, device, or apparatus operable to retain program instructions or data for a period of time. Memory 104 may comprise random access memory (RAM), electrically erasable programmable read-only memory (EEPROM), a PCMCIA card, flash memory, magnetic storage, opto-magnetic storage, or any suitable selection and/or array of volatile or non-volatile memory that retains data after power to information handling system 102 is turned off. Modules implementing memory 104 may be mounted to motherboard 101 via suitable connectors or sockets, and may be electrically coupled to motherboard 101 to enable communication of signals via motherboard 101 and enable memory 104 to receive electrical energy from motherboard 101 for powering memory 104.

GPU 106, which may also be referred to as a graphics card or graphics accelerator, may comprise a specialized electronic circuit designed for digital image processing and to accelerate computer graphics, but which may also find use for non-graphical applications including neural networks and cryptocurrency mining. GPU 106 may be mounted to motherboard 101 via a suitable connector or socket, and may be electrically coupled to motherboard 101 to enable communication of signals via motherboard 101. Further, GPU 106 may include a power header 110 configured to electrically couple to cable 114, and, as discussed in greater detail below, GPU 106 may receive electrical energy via cable 114 (e.g., in lieu of from motherboard 101) for powering GPU 106.

Power conversion module 108 may include any suitable system, device, or apparatus configured to perform power conversion of a voltage. Accordingly, power conversion module 108 may receive an input voltage from a battery or other power source (not explicitly shown in FIGS. 1 and 2) and convert such input voltage into an output voltage. In some embodiments, power conversion module 108 may be configured to perform EPR-to-SPR power conversion. In addition, power conversion module 108 may be configured to perform power sensing and/or power switching operations that are traditionally performed on a motherboard. As shown in FIGS. 1 and 2, power conversion module 108 may include a power header 112 configured to electrically couple to cable 114 in order to enable power conversion module 108 to deliver the output voltage via cable 114.

Cable 112 may comprise a plurality of electrically-isolated wires and may be terminated at each end with connectors or other terminations configured to electrically and mechanically couple to power header 110 and power header 112.

In addition to motherboard 101, processor 103, memory 104, GPU 106, power conversion module 108, and cable 114, information handling system 102 may include one or more other information handling resources.

In operation, power conversion module 108 may perform power conversion, power sensing, and power switching, and supply GPU 106 with electrical energy via dedicated cable 114, such that delivery of electrical energy for powering operation of GPU 106 bypasses motherboard 101. Accordingly, as compared to existing approaches, motherboard 101 may require less space, in terms of layers and routing for powering GPU 106. Further, as compared to existing approaches, a connector or socket of GPU 106 may be reduced in cost and size.

As used herein, when two or more elements are referred to as “coupled” to one another, such term indicates that such two or more elements are in electronic communication or mechanical communication, as applicable, whether connected indirectly or directly, with or without intervening elements.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative. Accordingly, modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

Although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described above.

Unless otherwise specifically noted, articles depicted in the drawings are not necessarily drawn to scale.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

Although specific advantages have been enumerated above, various embodiments may include some, none, or all of the enumerated advantages. Additionally, other technical advantages may become readily apparent to one of ordinary skill in the art after review of the foregoing figures and description.

To aid the Patent Office and any readers of any patent issued on this application in interpreting the claims appended hereto, applicants wish to note that they do not intend any of the appended claims or claim elements to invoke 35 U.S. C. § 112(f) unless the words “means for” or “step for” are explicitly used in the particular claim.

What is claimed is:

1. An information handling system comprising:
a motherboard;
a first processor mounted on the motherboard and electrically coupled to the motherboard and configured to receive electrical energy for powering the first processor via the motherboard and communicate signals via the motherboard;
a second processor mounted on the motherboard and electrically coupled to the motherboard and configured to communicate signals via the motherboard; and
a power converter module configured to:
convert an input voltage to an output voltage; and
deliver the output voltage via a dedicated cable coupled between the power converter module and the second processor.

2. The information handling system of claim 1, wherein the power converter module is further configured to perform power switching.

3. The information handling system of claim 1, wherein the power converter module is further configured to perform power sensing.

4. The information handling system of claim 1, wherein the power converter module comprises an Extended Power Range to Standard Power Range power converter.

5. The information handling system of claim 1, wherein the second processor comprises a graphics processing unit.

6. A power converter module comprising:
a power converter configured to convert an input voltage to an output voltage; and
a power header configured to couple to a dedicated cable to deliver the output voltage via the cable.

7. The power converter module of claim 6, further comprising circuitry for performing power switching.

8. The power converter module of claim 6, further comprising circuitry for performing power sensing.

9. The power converter module of claim 6, wherein the power converter comprises an Extended Power Range to Standard Power Range power converter.

10. The power converter module of claim 6, wherein the power header is configured to couple via the cable to a processing device.

11. The power converter of claim 10, wherein the processing device comprises a graphics processing unit.

12. A method comprising:
coupling a power converter module to a processing device via a dedicated cable, wherein the power converter module is configured to:
convert an input voltage to an output voltage; and
deliver the output voltage to the processing device via the dedicated cable.

13. The method of claim 12, wherein the power converter module is further configured to perform power switching.

14. The method of claim 12, wherein the power converter module is further configured to perform power sensing.

15. The method of claim 12, wherein the power converter module comprises an Extended Power Range to Standard Power Range power converter.

16. The method of claim 12, wherein the processing device comprises a graphics processing unit.
